(19) United States
(12) Patent Application Publication
(10) Pub. No.: US 2025/0355137 A1
(43) Pub. Date: Nov. 20, 2025

(54) THREE-DIMENSIONAL ISOTROPIC METAMATERIAL, METHOD OF PRODUCING THE SAME, AND TERAHERTZ REGION OPTICAL ELEMENT INCLUDING THE METAMATERIAL

(71) Applicant: TOHOKU UNIVERSITY, Sendai-shi (JP)

(72) Inventors: Yoshiaki KANAMORI, Sendai-shi (JP); Kazuhiro HANE, Sendai-shi (JP)

(73) Assignee: TOHOKU UNIVERSITY, Sendai-shi (JP)

(21) Appl. No.: 19/286,031

(22) Filed: Jul. 30, 2025

Related U.S. Application Data
(62) Division of application No. 17/432,194, filed on Aug. 19, 2021.

(51) Int. Cl. G02B 1/00; H01P 7/08; H01P 11/00; H01Q 15/02

(52) U.S. Cl. CPC G02B 1/002; H01P 7/08; H01P 11/008; H01Q 15/02

(57) ABSTRACT

A three-dimensional isotropic metamaterial including an aggregate of SRR-buried block pieces obtained by burying SRRs in a transparent resin cube, at random in a transparent resin member; a method of producing the same; and a terahertz region optical element.

### CROSS-REFERENCE TO RELATED APPLICATIONS

This application is a Divisional Application of U.S. application Ser. No. 17/432,194 filed Aug. 19, 2021, which is a National Stage of International Application No. PCT/JP2019/013481 filed Mar. 27, 2019, the disclosures of all of which are hereby incorporated by reference in their respective entirety.

### FIELD OF THE INVENTION

The present invention relates to a three-dimensional isotropic metamaterial. More specifically, the present invention relates to a three-dimensional isotropic metamaterial, a terahertz region optical element including the three-dimensional isotropic metamaterial, and a method of producing a three-dimensional isotropic metamaterial.

### BACKGROUND OF THE INVENTION

Terahertz waves are electromagnetic waves having a frequency of about 0.1 to 10 THz, and have a fingerprint spectrum specific to material, and high permeability. Because terahertz waves exert small influence on a biological body, terahertz waves are considered to be usable in sensing in security and medical fields, and active research has been recently conducted. For example, it has been reported that success has been achieved in determination of medicine in an envelope based on a difference in transmission spectra of terahertz waves (Optics Express, vol. 11, 2549 to 2554, 2003; Non Patent Literature 1).

Nevertheless, a sensing technology in a terahertz region is nonfully-developed. The reason lies in that low-loss materials that can be used as an optical element in a terahertz band are as listed in Table 1, and a design freedom degree is small.

TABLE 1
Refractive index of material for terahertz element

| Material name | Refractive index in terahertz band |
|---|---|
| Polymethylpentene (TPX) | 1.456 ± 0.001 (1 to 10 THz) |
| Polyethylene | 1.52 ± 0.02 (1 to 8 THz) |
| COP (Tsurupica) | 1.56 |
| Diamond | 2.383 ± 0.002 (4.25 to 6.3 THz) |
| Silicon single crystal (Si) | 3.4175 ± 0.0001 (0.5 to 4.5 THz) |
| PTFE (Teflon) | 1.44 to 1.48 (1.5 to 6 THz) |

Thus, as a material that can control optical characteristics such as transmission and refraction, a metamaterial being an artificial structure formed of minute metal smaller than a wavelength has been proposed. It is indicated that, in a terahertz region, by producing a pattern of a metal wire on a polymer film, a refractive index equal to or larger than double of a refractive index of a conventional material can be obtained in a specific frequency (Infrared Milli Terahz Waves, vol. 38, 1130 to 1139, 2017; Non Patent Literature 2), and the metamaterial is expected to be used in compact and high-performance lens, prism, and the like. A split ring resonator (hereinafter, abbreviated as an SRR) illustrated in FIGS. 1(a) and 1(b) is a resonator obtained by providing a gap in a part of a ring, and can be regarded as an LC resonance circuit in which a gap portion is used as a capacitance, and can change a refractive index near a resonance frequency in principle (Optics Letters, vol. 30, 1348 to 1350, 2005; Non Patent Literature 3).

Both metamaterials described in Non Patent Literatures 2 and 3 have a planar periodic structure, and a response is limited to a specific incident direction. Nevertheless, a structure of similarly responding in all incident directions is actually demanded. In addition, a thickness structure of being equal to or larger than a millimeter (mm) order is also demanded for ensuring a sufficient interaction distance with electromagnetic waves.

For solving this issue, a metamaterial having a three-dimensional structure having isotropic optical characteristics by a minute structure becomes necessary. Nevertheless, in a generally-used lithography method, it is difficult to create a thick structure, and a new method is demanded.

So far, there has been proposed a method of producing an SRR on a resin wall surface as a three-dimensional metamaterial (Adv. Mater. vol. 22, 5053 to 5057, 2010; Non Patent Literature 4). This method constructs one layer on the outside of a substrate plane, and has a limitation in manufacturable thickness. In addition, a metamaterial in which a layer patterned with an SRR is overlaid on a substrate has been reported (Nature Materials, vol. 7, 31 to 37, 2008; Non Patent Literature 5). According to Non patent Literature 5, a limitation in manufacturable thickness is eliminated, but there is a limitation in the direction of the SRR, and there is such a problem that characteristics vary depending on the direction. Accordingly, in the current situation, a metamaterial having complete isotropy has not been realized yet.

### CITATION LIST

### Non-Patent Literatures

Non Patent Literature 1: Optics Express, vol. 11, 2549 to 2554 (2003)
Non Patent Literature 2: Infrared Milli Terahz Waves, vol. 38, 1130 to 1139 (2017)
Non Patent Literature 3: Optics Letters, vol. 30, 1348 to 1350 (2005)
Non Patent Literature 4: Adv. Mater., vol. 22, 5053 to 5057 (2010)
Non Patent Literature 5: Nature Materials, vol. 7, 31 to 37 (2008)

### SUMMARY OF THE INVENTION

### Technical Problem

The present invention provides a metamaterial in which meta-atoms (metamaterial unit structure) such as SRRs are buried in such a manner as to three-dimensionally disperse in a transparent medium (resin) independent of direction, and a method of producing the same, and verifies that a produced metamaterial has desired optical characteristics (isotropy, refractive index control property).

### Solution to Problem

Using methods to be described later in the section of mode for carrying out the invention, the present inventors have performed design (calculation and response), producing, and experiment of a three-dimensional model as for a metamaterial structure for a three-dimensional isotropic terahertz region, showed the usefulness of a three-dimensional metamaterial having a random structure, by calculation using a finite integration technique (FIT), established a method of producing a three-dimensional metamaterial in which SRRs disperse in a cycloolefin polymer (COP) independent of direction, and verified and confirmed that polarization dependence of the produced three-dimensional metamaterial has been resolved as compared with a planar periodic structure, by measuring optical characteristics (isotropy, refractive index control property) of the produced metamaterial. Then, it has been confirmed that a refractive index of 1.50 to 1.60 is realized in a 0.35 THz band, and a refractive index of 1.43 to 1.60 is realized in a 0.7 THz band, by the produced three-dimensional metamaterial, and the present invention has been completed.

In other words, the present invention provides a three-dimensional isotropic metamaterial according to [1] to described below, a method of producing the same, and a product including the metamaterial.

[1] A three-dimensional isotropic metamaterial, including an aggregate of meta-atom block pieces in which meta-atoms are buried in a transparent resin, in a transparent resin member.
[2] The three-dimensional isotropic metamaterial according to the previous item 1, wherein the meta-atom is an SRR.
[3] The three-dimensional isotropic metamaterial according to the previous item 2, wherein an SRR block piece aggregate in which SRRs are buried in a central part of the transparent resin member cube or a vicinity of the central part is included in the transparent resin member.
[4] The three-dimensional isotropic metamaterial according to the previous item 2 or 3, wherein a size of the SRR block is set to a ring width w of 1 μm or more, an average radius r of 1 to 500 μm, and a period (one piece) a of 3 to 3,000 μm.
[5] The three-dimensional isotropic metamaterial according to the previous item 4, wherein the SRR is formed of a conductive material (conductive member).
[6] The three-dimensional isotropic metamaterial according to the previous item 5, wherein the conductive member is at least one type selected from the group consisting of a metal material, a transparent conductive oxide, and a carbon material.
[7] The three-dimensional isotropic metamaterial according to any of the previous items 1 to 6, wherein a material of the transparent resin member is a transparent nonconductive material for light in a terahertz region.
[8] A method of producing a three-dimensional isotropic metamaterial, including the steps of:
a step (P1) of forming a conductive member film on a transparent resin film (1a) and etching the conductive member film to form a meta-atom block aggregate;
a step (p2) of bonding transparent resin films (1b) after coating the meta-atom block aggregate with transparent resin solution;
a step (p3) of splicing the transparent resin film (1a) to a substrate sheet (2) after drying;
a step (p4) of dicing the meta-atom block aggregate into a predetermined size, and then removing the diced aggregate from the substrate sheet (2) as a block piece in which a meta-atom is buried in a transparent resin (1); and
a step (p5) of uniformly dispersing the meta-atom buried block pieces in transparent resin solution in a mold and then causing curing, and extracting a cured molded member from the mold.
   [9] The method of producing a three-dimensional isotropic metamaterial according to the previous item 8, wherein the meta-atom block is an SRR block.
   [10] The method of producing a three-dimensional isotropic metamaterial according to the previous item 9, wherein a size of an SRR block is set to a ring width w of 1 μm or more, an average radius r of 1 to 500 μm, and a length a of a period (one piece) of 3 to 3,000 μm.
   [11] The method of producing a three-dimensional isotropic metamaterial according to any of the previous items 8 to 10, wherein the conductive member is at least one type selected from the group consisting of a metal material, a transparent conductive oxide, and a carbon material.
   [12] The method of producing a three-dimensional isotropic metamaterial for a terahertz region optical element according to any of the previous items 8 to 11, wherein a resin material of the transparent resin film and transparent resin solution is a transparent nonconductive material for light in a terahertz region.
   [13] A product, including the three-dimensional isotropic metamaterial according to any of the previous items 1 to 7.
   [14] The product according to the previous item 13, wherein the product is a terahertz region optical element.

### Advantageous Effects of Invention

By the realization of a three-dimensional isotropic metamaterial and a terahertz region optical element including the same according to the present invention, the use of electromagnetic waves of terahertz waves (frequency 0.1 to 10 THz) that have a fingerprint spectrum specific to material, and high permeability, and exert small influence on a biological body has become practical. The application field of terahertz region light is not specifically limited, and a three-dimensional isotropic metamaterial is applied to, for example, a filter without angle dependence, a thin lens, a spectroscope that uses a prism, and the like.

Furthermore, in a case where a three-dimensional isotropic metamaterial is used in a terahertz region optical element, examples include products, systems, apparatuses, and the like that are related to the application of a transparent mantle for terahertz, a stealth technology equipped product (terahertz wave reflection/absorption suppression technique), a radio disturbance resolution technique equipped product (operate a direction of terahertz waves), a high-sensitive ultracompact antenna, an IC tag, a high-angle beam scanning antenna, a near-field microscope device, a high-efficiency detector, terahertz waveband optical waveguide/optical fiber, a dangerous object inspection device, an airport security inspection device, a body scanner (used in finance, information terminal room, airport, etc.), a doping test device, a biometric authentication device (used in finance, information terminal room, airport, etc.), a food quality safety inspection device, a food quality management device, an agricultural crop inspection device, a medicinal product inspection device, a biotip/DNA analysis device, a cancer diagnosis device, a semiconductor wafer evaluation device, an LSI failure inspection device, an atmosphere environment analysis device, and the like.

### BRIEF DESCRIPTION OF THE DRAWINGS

FIG. 1(a) is an operating principle diagram of an SRR and FIG. 1(b) is an equivalent circuit diagram of an SRR.

FIG. 2 illustrates a unit cell of a two-dimensional model.

FIG. 3 illustrates a unit cell of a three-dimensional model.

FIG. 4(1) is an explanatory diagram of operations of an electric response of an SRR, and FIG. 4(2) is an explanatory diagram of operations of a magnetic response of an SRR.

FIG. 5 illustrates transmission characteristics of an electric response (1) and a magnetic response (2) of an SRR.

FIG. 6 illustrates a size example of an SRR block.

FIG. 7 illustrates a response frequency shift caused by a period change of an SRR.

FIG. 8 illustrates a two-dimensional model obtained by rotating an SRR about a y-axis by 90°.

FIG. 9 illustrates a change in transmission characteristics caused by rotating an SRR about an x-axis.

FIG. 10 illustrates a change in transmission characteristics caused by rotating an SRR about the y-axis.

FIG. 11 illustrates a change in transmission characteristics caused by rotating an SRR about a z-axis.

FIG. 12 is an explanatory diagram of orthogonal arrangement of SRRs.

FIG. 13 is an explanatory diagram of rotation of an SRR.

FIG. 14 illustrates a three-dimensional model example.

FIG. 15 illustrates averaged transmission characteristics.

FIG. 16 illustrates refractive index characteristics of a three-dimensional model (three layers).

FIG. 17 illustrates a change in transmission characteristics caused by a density change of an SRR.

FIG. 18 illustrates a change in transmission characteristics caused by a dimension change of an SRR.

FIG. 19 illustrates a relationship between the number of layers, and a smallest transmittance, a largest refractive index and a smallest refractive index in a case where the number of layers of an SRR is changed.

FIG. 20 illustrates incident angle dependence of a transmittance of a two-dimensional model.

FIG. 21 illustrates polarization dependence of a transmittance of a two-dimensional model.

FIG. 22 illustrates incident angle dependence of a transmittance of a three-dimensional model.

FIG. 23 illustrates polarization dependence of a transmittance of a three-dimensional model.

FIG. 24 illustrates a flow for producing a three-dimensional metamaterial.

FIGS. 25(a) to 25(k) illustrate an example of a process for producing a three-dimensional metamaterial.

FIG. 26 shows an example of a produced SRR pattern.

FIG. 27 shows an example of a diced SRR block.

FIG. 28 shows an SRR in a block.

FIG. 29 shows a photograph of an extracted SRR block aggregate.

FIG. 30 shows a photograph of a metamaterial example after polishing.

FIGS. 31(1) to 31(4) show photomicrographs of a three-dimensional metamaterial in which a focal position is deepened from a surface vicinity.

FIG. 32 shows an image of an SRR pattern (a=125 μm) produced on a COP film.

FIG. 33 shows a photograph of three-dimensional metamaterials produced using SRR blocks of two types with difference sizes.

FIG. 34 is a photograph of a three-dimensional metamaterial having a prism shape.

FIG. 35 illustrates a direction of an electromagnetic field of polarized light x in an SRR film.

FIG. 36 illustrates transmission characteristics (r=46 μm) of an SRR film.

FIG. 37 illustrates a refractive index characteristics (r=46 μm) of an SRR film.

FIG. 38 illustrates a direction of an electromagnetic field of polarized light x in a three-dimensional metamaterial.

FIG. 39 illustrates transmission characteristics (a=200 μm, r=46 μm) of a three-dimensional metamaterial.

FIG. 40 illustrates transmission characteristics (a=200 μm, r=46 μm) of a three-dimensional metamaterial.

FIG. 41 illustrates transmission characteristics (a=200 μm, r=86 μm) of a three-dimensional metamaterial.

FIG. 42 illustrates refractive index characteristics (a=200 μm, r=86 μm) of a three-dimensional metamaterial.

FIG. 43 illustrates transmission characteristics (a=100 μm, r=46 μm) of a three-dimensional metamaterial.

FIG. 44 illustrates refractive index characteristics (a=100 μm, r=46 μm) of a three-dimensional metamaterial.

FIG. 45 is an image diagram of refraction angle verification using a prism.

FIG. 46 illustrates frequency characteristics (r=86 μm, a=200 μm) of a refraction angle.

FIG. 47 illustrates frequency characteristics (r=46 μm, a=100 μm) of a refraction angle.

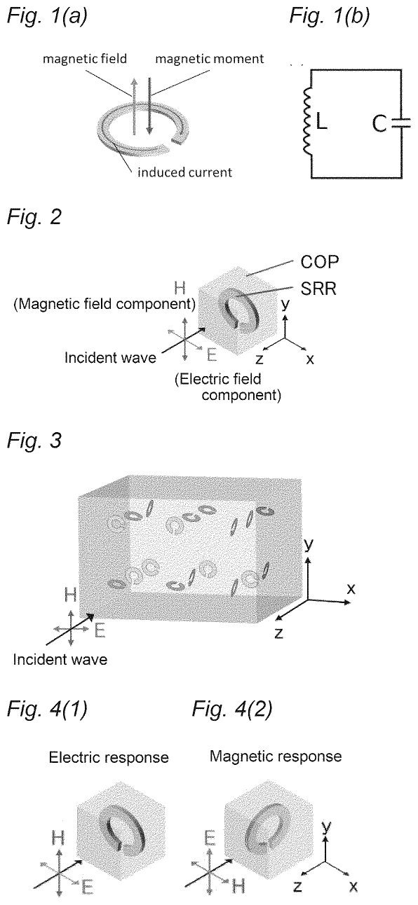

### DESCRIPTION OF EMBODIMENTS

A structure of a three-dimensional isotropic terahertz metamaterial of the present invention will be described in the order of design (calculation and response) of a three-dimensional model, a producing, and an experiment result.

First of all, calculation for predicting a response of a metamaterial to be produced was performed using a finite integration technique. First of all, a model obtained by periodically arraying an SRR of one pattern in xy directions was used as a two-dimensional model, and a response made when an SRR is slanted was checked as a basic response to electromagnetic wave while assuming that almost all SRRs are obliquely arranged with respect to an incident wave in random arrangement (FIG. 2). Then, a model obtained by arranging three layers in a z direction with six patterns of directions of SRRs was used as a three-dimensional model (FIG. 3), and a response of a random structure was predicted. After a calculation method was determined, a basic response to vertical incidence was checked, and in a case where arrangement is random and has no periodicity, whether or not a response is indicated in a frequency band as designed was checked while changing a dimension and a period of the SRR, and lastly, whether or not polarization dependence or incident angle dependence is resolved was checked.

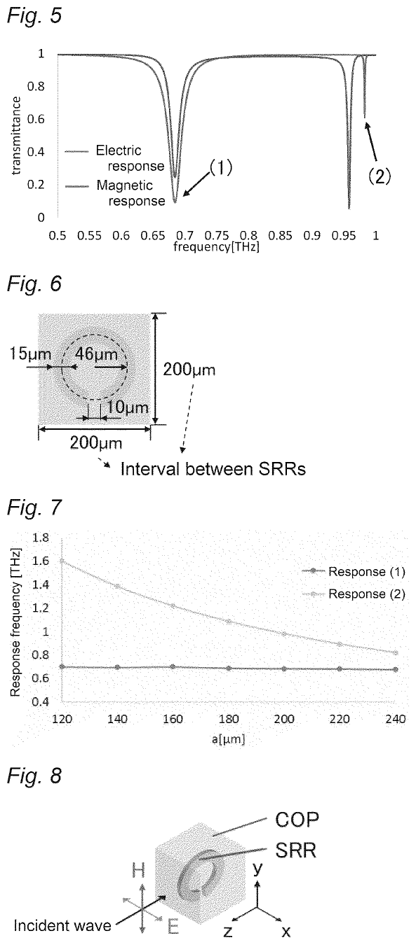

A basic operation of a split ring (SRR) will be described. An SRR indicates a response indicating whether an electric field component of an incident wave basically goes along a gap, using a specific frequency when a magnetic field component is vertical to a ring plane and a magnetic field penetrates through a ring. FIGS. 4 and 5 illustrate transmission characteristics obtained when an electric field response and a magnetic field response are indicated. A feature lies in that a common response (response corresponding to a first dipole resonance and LC resonance) was observed near 0.7 THz, but the response depends on an SRR shape parameter and influence of periodicity is small. It can be seen that, when a period (interval between SRRs) is changed for this response and a response of another frequency, a response frequency hardly shifts in first resonance (FIGS. 6 and 7).

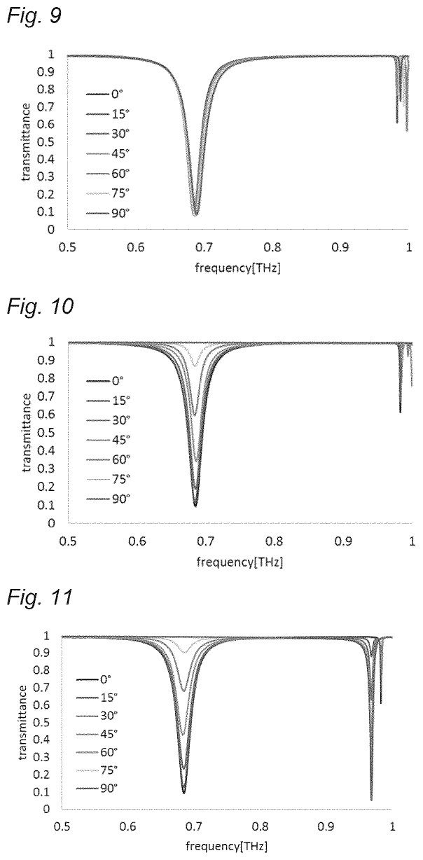

Next, a response made when an SRR is slanted with respect to vertical incidence was checked (FIGS. 8 to 11). FIG. 8 illustrates a two-dimensional model obtained when an SRR is rotated about a y-axis by 90°. Because a gap and an electric field are always parallel at the time of x-axis rotation and a response component is not lost, a response hardly changes (FIG. 9). Because components causing LC resonance gradually decrease as for y-axis (FIG. 10) and z-axis (FIG. 11) rotation, a response weakens but a frequency shift does not occur. From the above points, it can be seen that, if an electric field or a magnetic field includes a responding component only slightly, a response is indicated at a fixed frequency.

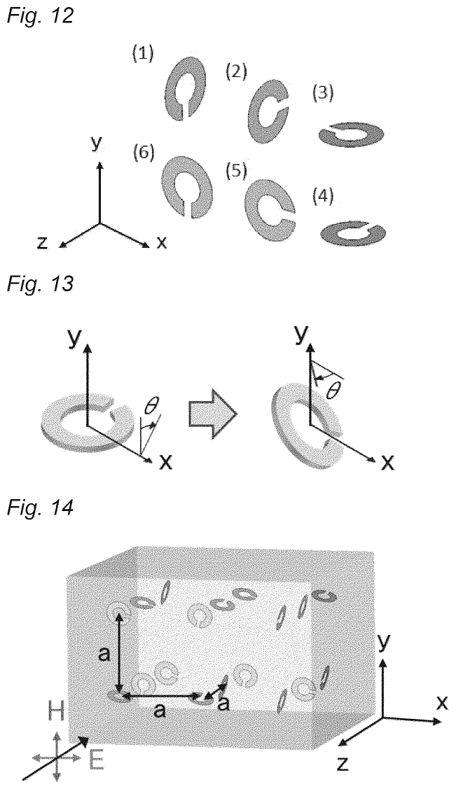

Next, a response of a three-dimensional metamaterial with SRR random arrangement that is to be produced was predicted by simulation. In a case where an SRR is arranged so as to be orthogonal to each axis, directions of six patterns illustrated in (1) to (6) of FIG. 12 are considered. In this arrangement, any of the SRRs makes a response in every incident direction. A model obtained by obliquely arranging SRRs with being rotated in the x-axis direction or the y-axis direction by 0 for achieving a random arrangement structure, based on the basic arrangement, causing all SRRs to make a response to vertical incidence (FIG. 13), and installing this in three layers in such a manner that the same-direction SRRs do not overlap was used as a three-dimensional model (FIG. 14). The characteristics of a random three-dimensional metamaterial structure were predicted by performing simulation of a pattern in which a rotational angle of this model is changed, and performing averaging.

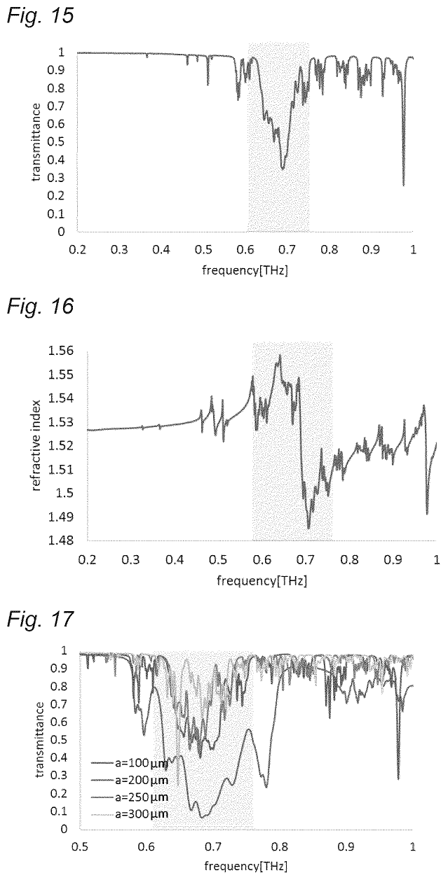

When seven transmission characteristics calculated while changing an angle are averaged, it was revealed that a transmittance largely drops near 0.7 terahertz (FIG. 15). From the above point, it can be predicted that, even if SRRs are arranged at random, a response is indicated in the same frequency band as a periodic structure. Also for a refractive index, a change can be observed in a corresponding frequency band (FIG. 16).

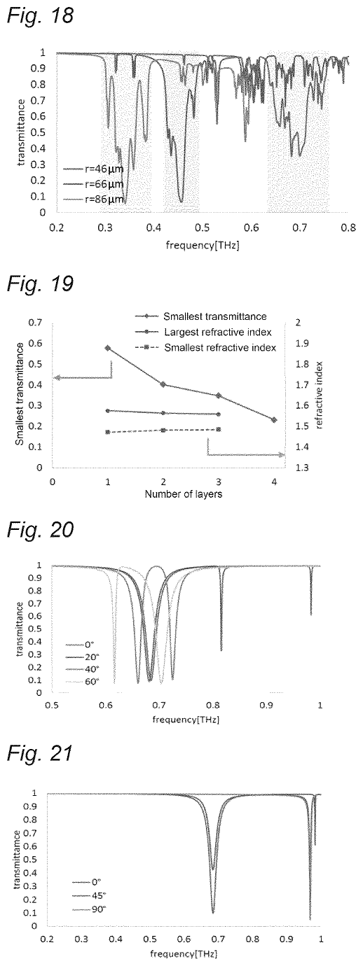

Next, a change in a response made when a period and a size of an SRR are changed was checked by simulation. First of all, when a period is changed from 120 μm to 280 μm, a spectrum shape changes, but a response frequency band did not change (FIG. 17). When a dimension (average radius) of an SRR is changed from 46 μm to 86 μm, a response shifts toward a low-frequency side (FIG. 18). Even if a period is changed, a response does not change, and if an average radius of an SRR is changed, a response shifts. Thus, a response of a three-dimensional model is considered to depend not on periodicity but on characteristics of an SRR itself.

A change in a response made when the number of layers of the above-described three-dimensional model of SRR 3 layer arrangement is changed was checked. From this calculation, it is considered that, as a thickness of a metamaterial increases, a drop in transmittance becomes larger (FIG. 19).

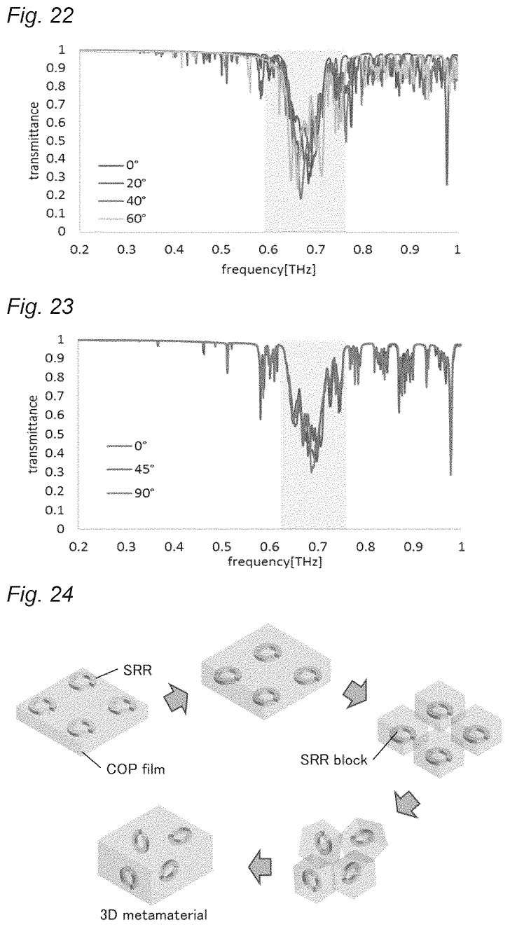

Next, polarization dependence and incident angle dependence were compared with those of a planar structure (FIGS. 20 and 21). In a case where polarized light of an incident wave is changed, a response changes each time a planar structure slants by 45° or 90°, but all three-dimensional models indicate similar characteristics. It was identified that, even if an incident angle is slanted up to 40°, characteristics do not change, and a response is indicated near 0.7 THz (FIGS. 22 and 23). From the above-described results, it is considered that, by arranging SRRs at random, direction dependence can be resolved.

From the above-described calculation results, it was predicted that a metamaterial to be produced makes a response at a specific frequency irrespective of periodicity, and the response does not depend on an incident direction of terahertz waves. If the characteristics can be realized, direction dependence existing in a conventional optical filter can be resolved.

### Producing of Three-Dimensional Metamaterial

FIG. 24 illustrates a flow diagram illustrating an overview of a process of producing a three-dimensional metamaterial. The process creates a material in which SRRs are arrayed in a cycloolefin polymer (COP) film, cuts the material so as to divide the material into individual SRRs, integrates blockish SRRs and forms a shape, and three-dimensionally disperse SRR blocks in the aggregate of the COP.

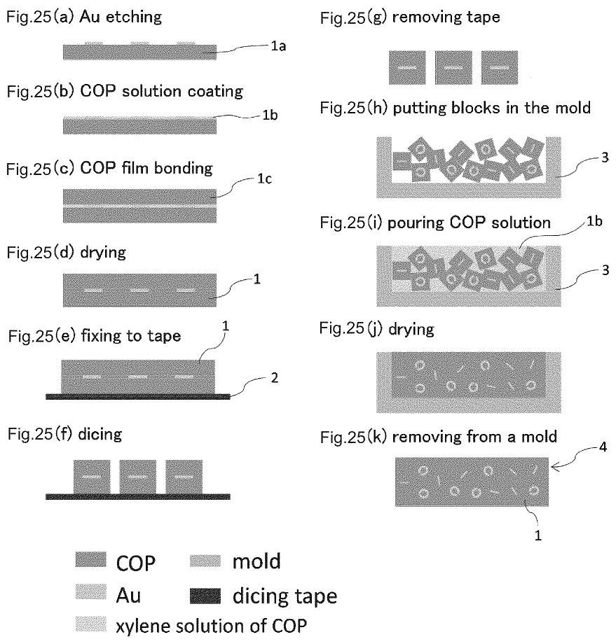

The details (steps) of an example of a producing process are illustrated in (FIG. 25) (a) to (k).

A metal film (Au film) is formed on a transparent resin film (COP film) (1a), the Au film is etched by photolithography, and an SRR block aggregate with an SRR ring width w (μm), an average radius r (μm), and a length a (μm) of a period (one piece) is formed (a), the SRR block aggregate is coated with resin solution (COP solution) (1b) (b), and then, the transparent resin films (COP film)(1b) are bonded (c). Herein, instead of bonding resin films, a film of transparent resin material may be formed by a technique such as spin coating, sputtering, or CVD. Note that the average radius r (μm) corresponds to a radius up to the center of an SRR ring width w (μm) as illustrated in FIG. 6.

Subsequently, after performing drying in a vacuum (d), the COP film (1c) is spliced to a tape shaped substrate (2) (e). The SRR block aggregate is diced into individual SRR blocks (f), an SRR-buried block is removed from the tape shaped substrate (2) (g), and an SRR-buried block aggregate is obtained. The aggregate of SRR-buried blocks is put into a mold (3) (h), and transparent resin (COP) (1b) solution is poured and blocks are uniformly dispersed (i), and then, drying and curing are performed (j). A three-dimensional metamaterial (4) is obtained as a cured molded member (k).

QUICK COATER SC-701HMCII manufactured by Sanyu Electron Co., Ltd. was used for sputtering. An SUSS aligner was user for photolithography. A designed dimension of an SRR block was set to an average radius r=46 μm, an SRR ring width w=15 μm, a gap g=10 μm, and a length a of a period (one piece)=200 μm. An interval (period) between SRRs was set to 225 μm in consideration of a width to be cut in dicing. ZeonorFilm (registered trademark) ZF14 produced by Zeon Corporation and having a thickness of 100 μm was used for a COP film. Here, a method of cutting into a block piece is not limited to dicing, and a cutting method of pressing a blade, a method of cutting like a cutter, a mold press work of a pressing a mold, cutting using a wire saw, a precise machining work that uses a cutting tool such as a turning tool, or the like may be employed.

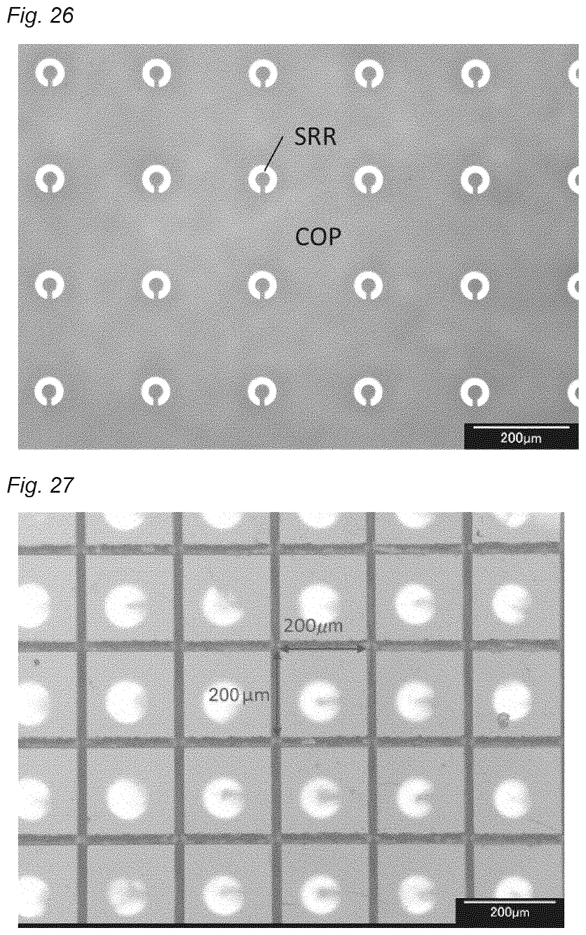

Note that a lithography range of an SRR pattern was set to 6 cm×6 cm (corresponds to 70756 SRRs per film.). FIG. 26 shows a photomicrograph of a produced SRR pattern. As illustrated in Table 2, SRRs could be produced on the COP film with sufficient accuracy.

A COP pellet (product name; Zeonex) manufactured by Zeon Corporation was used for preparation of COP solution. The COP solution was obtained by putting Zeonex into xylene, and completely dissolving Zeonex by stirring. The same films obtained by performing spin coating of COP solution was bonded.

TABLE 2
Designed dimension and producing dimension of SRR

| | Designed value | Producing dimension |
|---|---|---|
| | [μm] | [μm] |
| Average radius r | 46 | 46.1 |
| Ring width w | 15 | 14.6 |
| Gap g | 10 | 10.3 |

### Producing of SRR Block

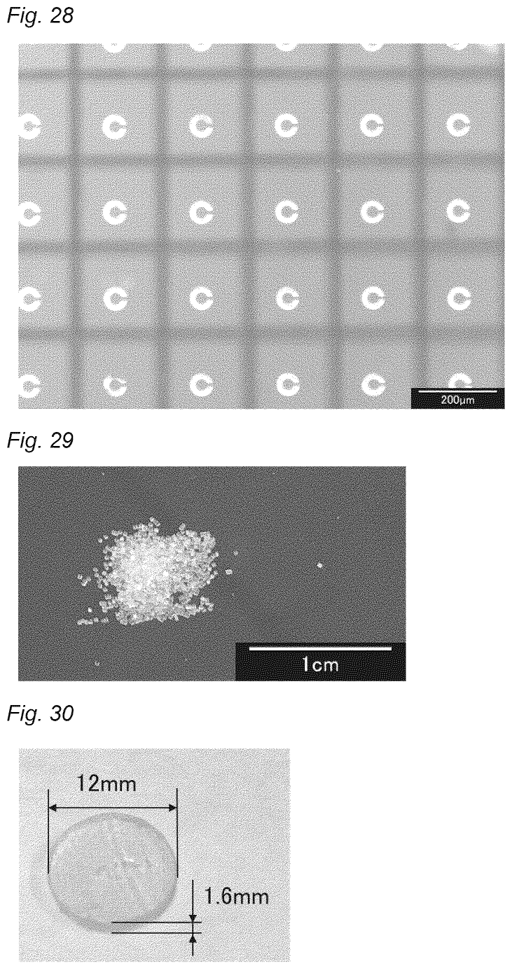

FIG. 27 shows diced SRR blocks. A block having one side with a dimension of 200 μm was accurately obtained. It can be confirmed that an SRR is included in a block (FIG. 28). After dicing, a sticky portion of a dicing tape was dissolved into solvent (acetone) and a block was extracted, cleaned using isopropyl alcohol (IPA), and dried using an oven. As shown in FIG. 29, a powdery SRR block aggregate was obtained. It can be confirmed from an enlarged photograph (not illustrated) that an SRR is encompassed in a COP block.

### Molding of SRR Block

A produced SRR block was put into an aluminum mold, and was molded using COP solution. In other words, after putting an SRR block into a mold, a step of pouring COP solution and drying was executed. Both surfaces of the molded metamaterial were polished using Automatic Lapping Polishing Machine MA-200D produced by Musashino Denshi, INC. FIG. 30 shows a polished metamaterial. The thickness of the obtained metamaterial was 1.6 mm, which corresponds to an aggregate of SRR block eight layers with 200 μm.

### Producing Result of Three-Dimensional Metamaterial

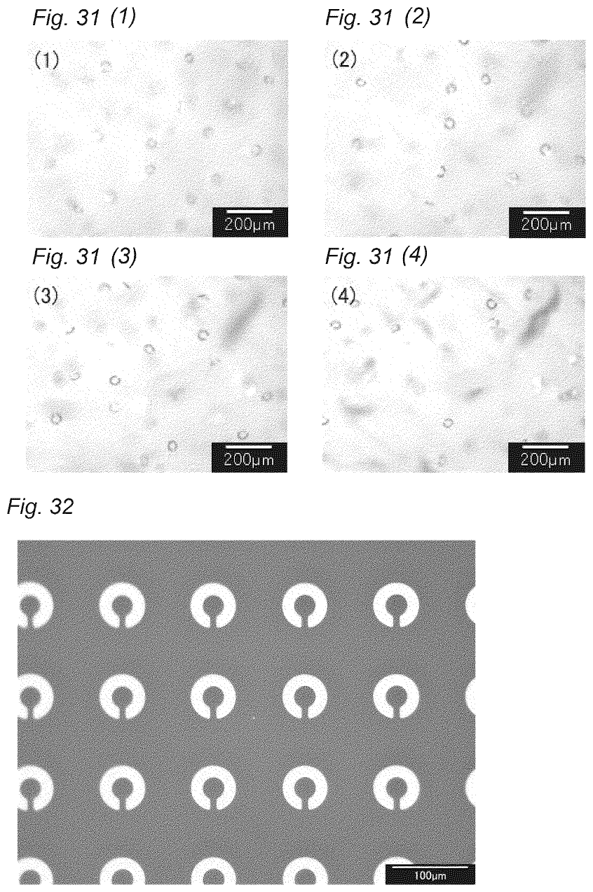

The produced three-dimensional metamaterial was observed using a microscope. FIG. 31 shows photographs obtained by observing one point on a metamaterial while changing a depth in which a focus is placed. When a focal position becomes deeper from the surface vicinity (1) to (4), a different SRR was observed, and it was confirmed that SRRs do not have direction dependence and positions of SRRs three-dimensionally exist at random, and a three-dimensional metamaterial in which SRRs disperse in COP at random was obtained. An average value of distances between SRRs calculated from the images in FIG. 31 was 226.5 μm. From this result, an SRR density in COP was estimated to be about 86/mm³. An SRR block is a cube having one side of 200 μm, and if SRR blocks are placed most densely, 125 SRR blocks are placed per 1 mm³. It was identified that the density of a produced metamaterial was about two-thirds of the densest state. When the dimension of an SRR is changed to r=86 μm in place of the above-described SRR with r=46 μm, and producing of a three-dimensional metamaterial was tried, and producing was succeeded even with a ring radius of 86 μm.

### Producing in Case Where Block Dimension Is Changed

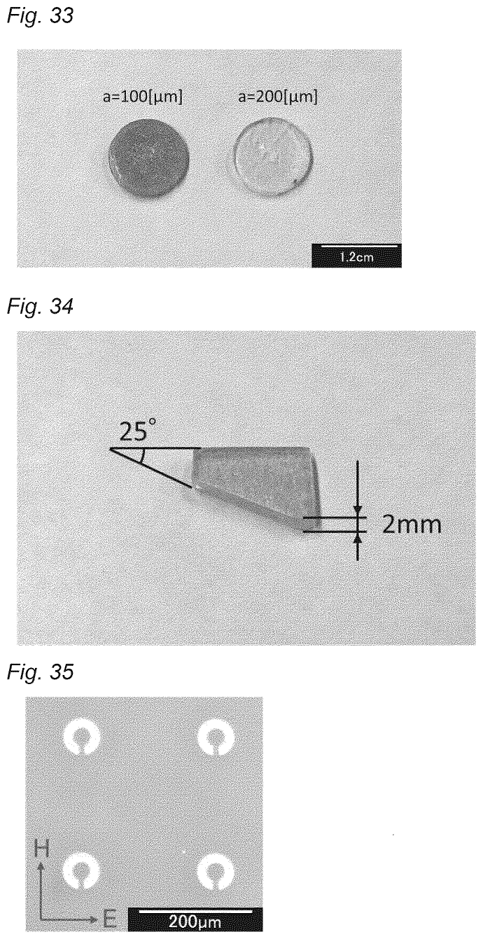

An SRR block having one side of 100 μm was produced, and producing of a dimensional metamaterial was similarly performed. FIG. 32 shows an image in which an SRR pattern was produced on a COP film. FIG. 33 shows a three-dimensional metamaterial produced using the 100 μm square block, together with a three-dimensional metamaterial produced using a 200 μm square block. It can be seen that the metamaterial produced using the 100 μm square block has darker gold color and higher density than the metamaterial produced using the 200 μm square block. The SRR density was estimated to be about 647/mm³.

### Producing of Prism That Uses Three-Dimensional Metamaterial

A prism-shaped metamaterial was produced using the above-described producing method. A designed dimension was set to r=86 μm, w=15 μm, g=10 μm, and a=200 μm. This is because a refractive index change larger than r =46 μm was obtained by measurement to be described later. A molding die for a prism shape was prepared, and molding and polishing were performed similarly to the above-described metamaterial. FIG. 34 shows a produced metamaterial. Molding can be performed similarly to the circular three-dimensional metamaterial shown in FIG. 30. A random dispersed state of SRR can be confirmed by microscopic observation of the inside and the side surface of the prism, and it was confirmed that direction dependence does not exist in SRR arrangement.

### EXPERIMENTAL EXAMPLE

### Terahertz Time-Domain Spectroscopy (THz-TDS)

Optical characteristics of the produced three-dimensional metamaterial were measured using a terahertz time-domain spectroscopy (THz-TDS). Note that the THz-TDS is a method of obtaining an absorbing spectrum in a terahertz band from a Fourier-transform spectrum ratio of waveforms by measuring a waveform of an electromagnetic wave when a terahertz wave is emitted and transmitted through a sample, and a waveform of an electromagnetic wave when a sample does not exist (Terahertz Spectroscopy, J. Phys. Chem., vol. 106, 7146 to 7159, 2002, C. R. Acad Sci., vol. 4, 983 to 988, 2001).

### Measurement of Metamaterial

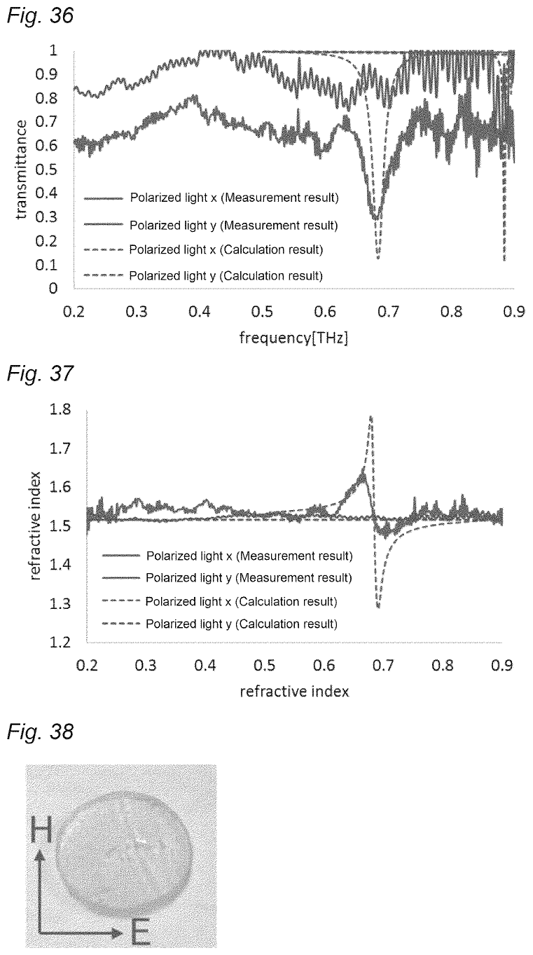

Transmission characteristics obtained when a terahertz wave vertically enters a sample of a metamaterial was checked. A metamaterial obtained by ending film splicing in the producing process illustrated in FIG. 25 and performing drying was prepared as a comparison target. As the dimension of an SRR, an interval a of the SRR is 225 μm as indicated in Table 2 provided above. As illustrated in FIG. 35, measurement of an SRR film was performed while assuming that polarized light changed by 90° from polarized light x in a case where an electric field component is parallel to a gap is regarded as polarized light y. FIG. 36 illustrates transmission characteristics obtained at this time, together with a calculation result of a two-dimensional model created using a producing dimension. While a drop in transmittance is observed near 0.7 THz in the polarized light x, the response is not observed in the polarized light y. As for refractive index characteristics, a response is observed near 0.7 THz only in the polarized light x as illustrated in FIG. 37. From this, it can be seen that an SRR film having a periodic structure in which SRRs are two-dimensionally arrayed has polarization dependence. A frequency at which a drop in transmittance is observed in the polarized light x conforms well with a calculation result.

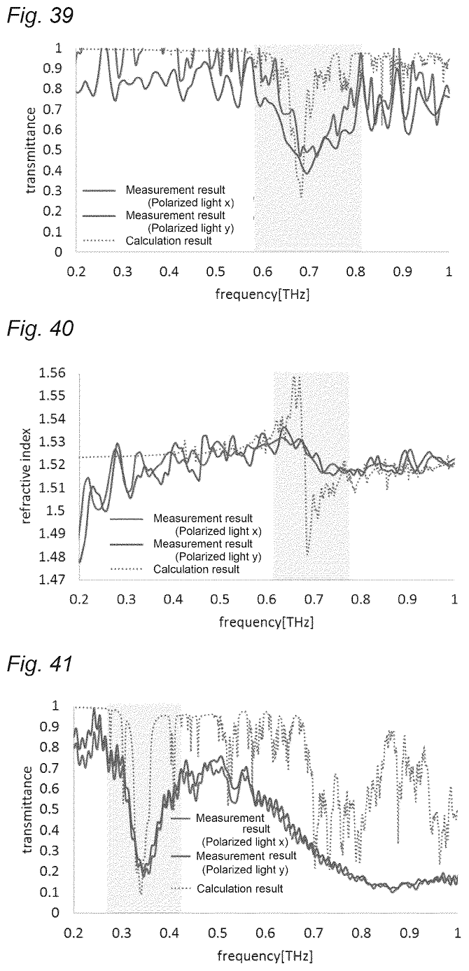

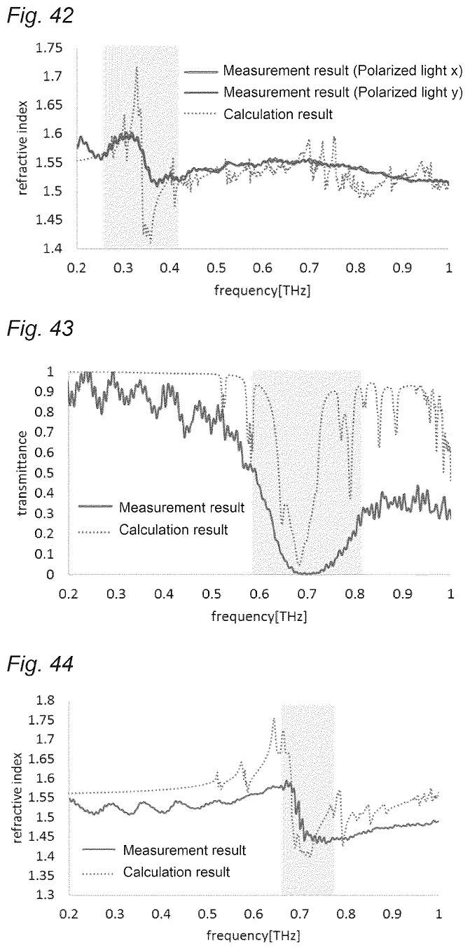

Next, a measurement result of a three-dimensional metamaterial will be described. Although directions of SRRs are not uniform in a three-dimensional metamaterial, for checking characteristics caused by polarized light, a direction of polarized light in FIG. 38 was defined as the polarized light x. In contrast to this, polarized light obtained by rotating the polarized light by 90° corresponds to the polarized light y. FIG. 39 illustrates measurement results of transmittances in these types of polarized light. FIG. 39 also illustrates a calculation result of a model that reproduces a producing dimension of an SRR of a produced metamaterial, and a measurement value of a density. It was identified that a transmittance drops near 0.7 THz both in the polarized light x and the polarized light y, and polarization dependence is resolved in the produced three-dimensional metamaterial as compared with a film state. FIG. 40 illustrates characteristics of a refractive index at this time. A refractive index change of 1.51 to 1.53 was observed near 0.7 THz both in the polarized light x and the polarized light y (calculation result was 1.48 to 1.56). FIG. 41 illustrates a measurement result of a transmittance of a three-dimensional metamaterial produced with an average radius r of an SRR being set to 86 μm. As compared with the time of r=46, a response frequency shifts toward a low-frequency side, and a transmittance drops near 0.35 THz. Responses of the polarized light x and the polarized light y conform well with each other. Furthermore, FIG. 42 illustrates characteristics of a refractive index at this time. A larger refractive index change of 1.50 to 1.60 (calculation result was 1.41 to 1.72) was obtained near 0.35 THz.

FIG. 43 illustrates a measurement result of a transmittance of a three-dimensional metamaterial produced with r=46 μm and a=100 μm. It can be seen that a transmittance drops to almost 0 near 0.7 THz. FIG. 44 illustrates characteristics of a refractive index at this time. A refractive index change near 0.7 THz was 1.43 to 1.60 (calculation result was 1.40 to 1.76), and a larger refractive index change than a case where a metamaterial is produced using a 200 μm square block was obtained. From measurement results of three-dimensional metamaterials of three types, it was identified that a response frequency band changes depending on the dimension of an SRR, and a size of a refractive index change changes depending on the density.

### Verification of Refraction Angle Using Prism

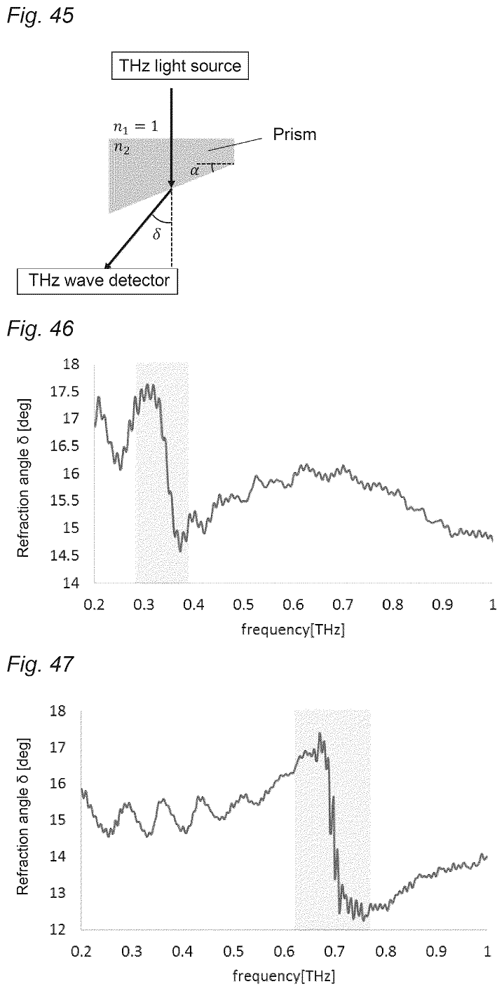

Similarly to the metamaterial shown in FIG. 34, a metamaterial of a trapezoidal prism is produced, and a refraction angle was checked using the following method. FIG. 45 illustrates an image diagram. A refraction angle δ can be identified by causing a terahertz wave to enter from the opposite side of an inclined side surface, and checking a position at which the intensity of the terahertz wave transmitted through the prism becomes the largest, while changing the position of a detector. The refraction angle δ can be calculated by the following equation (1).

$$\begin{matrix}[ Math . 1 ] & \\ δ = {sin}^{- 1} ( {n}_{2} sin α ) - α & ( 1 )\end{matrix}$$

When the prism of the metamaterial shown in FIG. 34 and produced with r =86 μm and a=200 μm is used, α=25° is obtained and a refractive index n₂ of the prism becomes as illustrated in FIG. 42. If the prism has refractive index characteristics at the time of the polarized light x in FIG. 45, by performing calculation using equation (1), a graph in FIG. 46 is obtained, and the refraction angle δ can be predicated to change from 14.45° to 17.63° in a response frequency band. Note that, in a case where a prism with the same shape is produced using only COP, the refraction angle δ becomes 14.86°. In addition, in a prism of a metamaterial having the same shape and produced with r=46 μm and a=100 μm, as illustrated in FIG. 47, the refraction angle δ changes from 12.24° to 17.40° in a 0.7 THz band, and an amount of the change can be predicted to be 5.16°. If a prism with the same shape is produced using teflon having the largest change in refractive index in a terahertz band among materials listed in Table 1, the refraction angle δ changes from 12.49° to 13.72°, and an amount of the change becomes 1.23°. From this, in a prism produced using a metamaterial proposed in the present invention, resolution drastically higher that of a conventional material can be realized at a specific frequency.

As described above, the present inventor et al. has performed verification of isotropy and refractive index control property as for a three-dimensional metamaterial in which SRRs disperse at random in COP. In a three-dimensional metamaterial proposed by calculation using a finite integration technique, anisotropy can be resolved as compared with a two-dimensional structure, and response frequency and intensity can be controlled by a dimension parameter. In addition, by a method of integrating cubic blocks each including one buried SRR, and molding the blocks, producing of a three-dimensional metamaterial was performed, the produced three-dimensional metamaterial was measured by the THz-TDS, and transmission characteristics and refractive index characteristics were evaluated.

By the calculation of a two-dimensional model, the first dipole resonance corresponding to LC resonance of an SRR is useful in creating a random structure without periodicity because a frequency shift caused by a change in periodicity is smaller as compared with resonance of another mode. When the same SRR is expanded to a three-dimensional model and calculation is performed, a response near 0.7 THz corresponding to a response frequency band of a two-dimensional model was confirmed. When calculation is performed while changing the dimension of the SRR, it was identified that, as an average radius of SRRs becomes larger, a response frequency band shifts toward a low-frequency side. In addition, when calculation is performed while changing the density of the SRR, it was identified that, although a response frequency band does not change, as a density becomes higher, a drop in transmittance and a variation in refractive index become larger. Furthermore, it was identified that, in the three-dimensional model, incident angle dependence and polarization dependence are resolved.

When measurement is performed using the THz-TDS, a response of the produced three-dimensional metamaterial approximately conform with a designed frequency. A metamaterial produced with an average radius r=46 μm and one side a of a block=200 μm has a transmittance dropping in a 0.7 THz band and a refractive index change of 1.51 to 1.53. In addition, also in a case where polarized light is rotated by 90°, a similar response is indicated, and it was confirmed that polarization dependence is resolved as compared with a two-dimensional structure. A metamaterial produced with r=86 μm and a=200 μm indicates a drop in a transmittance in a 0.35 THz band, and a refractive index change of 1.50 to 1.60 was obtained. In addition, the response conformed well with a response made when polarized light is rotated by 90°. A metamaterial produced with r=46 μm and a=100 μm has a transmittance dropping largely in a 0.7 THz band than that produced with a=200 μm, and the largest refractive index change of 1.43 to 1.60 was obtained.

A refractive index 1.60 realized by the present invention is a refractive index drastically higher than a resin material used as a conventional optical element.

As described above, the metamaterial obtained by the present invention realizes a refractive index that cannot be obtained by a natural material, in a terahertz region. According to the metamaterial of the present invention, because a refractive index can be freely set, a design freedom degree of an optical element increases. Specific examples to which the metamaterial of the present invention can be applied include a filter without angle dependence, a thin lens, a terahertz wave spectroscope that uses a prism, and the like, but the application is not limited to these.

### Meta-Atom (Metamaterial Unit Structure)

Heretofore, regarding the three-dimensional isotropic metamaterial of the present invention, the mode of an SRR-buried block for a terahertz region optical element has been described in detail, but the three-dimensional isotropic metamaterial of the present invention is not limited to a terahertz region. In addition, a meta-atom that can be used in a metamaterial is not limited to an SRR, and can be applied to metamaterial unit structures (meta-atoms) with various structures. For example, a three-dimensional isotropic metamaterial in which paired metal cut wires disclosed in applied physics, vol. 86, 897 to 902 (2017), omega-type metamaterials disclosed in Optic Communications, 283,2547 to 2551 (2010), or double split rings disclosed in IEEE Photonics journal, vol. 1, No. 2, 99 to 118, August (2009) are buried in a transparent resin member similarly to the case of an SRR can be considered.

The material of an SRR is only required to be an electricity-conducting material, and examples include a metal material, a transparent conductive oxide (ITO, IZO, ZnO, IGZO, etc.) used in a transparent electrode, and a carbon material such as graphene. Representative examples of the metal material include gold (Au), silver (Ag), copper (Cu), and aluminum (Al).

### Transparent Resin Material

The material of a transparent resin member that buries (encompasses) an SRR in the present invention is only required to be a transparent nonconductive material for light in a terahertz region. The material is not specifically limited, and examples include polymethylpentene, polyethylene, cycloolefin polymer (COP), silicon, polytetrafluoroethylene (Teflon; registered trademark), SiO₂, and the like. Among these materials, COP is preferable.

### Size of SRR to be Buried in Transparent Resin Member

The metamaterial of the present invention is preferably used for a terahertz region optical element with a frequency of 0.1 to 10 THz (wavelength of 30 to 3000 μm). Accordingly, a size of an SRR to be buried in a transparent resin material member is preferably set to a range of a ring width w of 1 μm or more, an average radius r of 1 to 500 μm, and a period (one piece) a of 3 to 3000 μm. More preferably, a size is set to w of 5 μm or more, r of 2 to 400 μm, and a of 10 to 2000 μm. Further preferably, a size is set to w of 10 μm or more, r of 3 to 300 μm, and a of 20 to 1000 μm. In addition, the ring width w of the metamaterial of the present invention is used in 1500 μm or less because a length of a period is limited.

### DESCRIPTION OF SYMBOLS

1 Transparent resin (COP)
1a, 1c Transparent resin (COP) film
1b Transparent resin (COP) solution
2 Tape shaped substrate
3 Mold
4 Three-dimensional isotropic metamaterial

1. A method of producing a three-dimensional isotropic metamaterial, comprising the steps of:
a step of preparing an aggregate of meta-atom buried block pieces in which each meta-atom is buried in a transparent resin, and
a step of uniformly dispersing the meta-atom buried block pieces in a transparent resin member.

2. The method of producing a three-dimensional isotropic metamaterial according to claim 1, wherein the meta-atom is a split ring resonator.

3. The method of producing a three-dimensional isotropic metamaterial according to claim 2, wherein the each meta-atom (split ring resonator) is buried in a central part or vicinity of the central part of the transparent resin.

4. The method of producing a three-dimensional isotropic metamaterial according to claim 2, wherein a size of the meta-atom (split ring resonator) buried block piece is set to a ring width w of 1 μm or more, an average radius r of 1 to 500 μm, and a period (one piece) a of 3 to 3,000 μm.

5. The method of producing a three-dimensional isotropic metamaterial according to claim 4, wherein the meta-atom (split ring resonator) is formed of a conductive material (conductive member).

6. The method of producing a three-dimensional isotropic metamaterial according to claim 5, wherein the conductive material is at least one type selected from a metal material, a transparent conductive oxide, and a carbon material.

7. The method of producing a three-dimensional isotropic metamaterial according to claim 1, wherein a material of the transparent resin is a transparent nonconductive material for light in a terahertz region, and a material of the transparent resin member is a transparent nonconductive material for light in a terahertz region.

8. The method of producing a three-dimensional isotropic metamaterial according to claim 7, wherein the transparent nonconductive material for light in a terahertz region is at least one kind selected from polymethylpentene, polyethylene, cycloolefin polymer, silicon, polytetrafluoroethylene and SiO2.

9. The method of producing a three-dimensional isotropic metamaterial according to claim 1, wherein the three-dimensional isotropic metamaterial has a refractive index of 1.50 to 1.60 in a 0.35 THz band and a refractive index of 1.43 to 1.60 in a 0.7 THz band.

10. The method of producing a three-dimensional isotropic metamaterial according to claim 1, wherein the step of uniformly dispersing the meta-atom buried block pieces in the transparent resin member is a step of uniformly dispersing the meta-atom buried block pieces in transparent resin solution followed by causing curing of the transparent resin solution.

11. The method of producing a three-dimensional isotropic metamaterial according to claim 1, comprising the steps of:
a step (P1) of forming a conductive member film on a transparent resin film (1a) and etching the conductive member film to form a meta-atom block aggregate;
a step (p2) of bonding transparent resin films (1b) after coating the meta-atom block aggregate with transparent resin solution;
a step (p3) of splicing the transparent resin film (1a) to a substrate sheet (2) after drying;
a step (p4) of dicing the meta-atom block aggregate into a predetermined size, and then removing the diced aggregate from the substrate sheet (2) as a block piece in which a meta-atom is buried in a transparent resin (1); and
a step (p5) of uniformly dispersing the meta-atom buried block pieces in transparent resin solution in a mold and then causing curing, and extracting a cured molded member from the mold.
